(19) United States
(12) Patent Application Publication
(10) Pub. No.: US 2026/0091888 A1
(43) Pub. Date: Apr. 2, 2026

(54) NANOSATELLITE SYSTEMS AND INTERFACES

(71) Applicant: University of Massachusetts, Westborough, MA (US)

(72) Inventors: Supriya Chakrabarti, Lowell, MA (US); Sunip Kumar Mukherjee, Lowell, MA (US); Mitchell Edward Bailey, Lowell, MA (US)

(73) Assignee: University of Massachusetts, Westborough, MA (US)

(21) Appl. No.: 19/348,160

(22) Filed: Oct. 2, 2025

Related U.S. Application Data
(60) Provisional application No. 63/702,208, filed on Oct. 2, 2024.

(51) Int. Cl. B64G 1/64; B64G 1/24; B64G 1/44

(52) U.S. Cl. CPC B64G 1/644; B64G 1/245; B64G 1/443

(57) ABSTRACT

A nanosatellite configured for launching from a cube satellite launcher is disclosed. The nanosatellite has a lower portion sized to the fit within the launcher housing, and has top, bottom, left, right, front and rear sides forming a payload housing. The top side has a top surface configured to engage with a front end of the spring of the launcher. The nanosatellite has an upper portion extending from the top surface of the lower portion, and is sized to fit within the spring of the launcher. A control subsystem contained within the upper portion. The nanosatellite may have one or more a solar panel arrays connected to the lower portion. In some embodiments, the solar arrays are movable between a stowed position against the lower portion and a deployed position extending outwardly from the lower portion. An additional 1U-3U of payload may be connected to the lower portion.

### CROSS-REFERENCE TO RELATED APPLICATIONS

This patent document claims priority to earlier filed U.S. Provisional Patent Application Ser. No. 63/702,208, filed on Oct. 2, 2024, the entire contents of which are incorporated herein by reference.

### BACKGROUND OF THE INVENTION

### 1. Field of the Invention

The present patent document is directed generally to nanosatellites and launchers for nanosatellites, and more particularly an improved nanosatellite system to increase the useful payload volume of CubeSat nanosatellite launchers.

### 2. Background of the Related Art

As shown in FIG. 1 (prior art), most commercial nanosatellite launchers (also called deployers) 10, by design, do not utilize the entirety of its volume to launch satellites 12. The spring-launch mechanism forces the use of spacers 14 within unused volume 16 that interfaces with the launcher spring 18 and pushes out the other satellites 12 along internal rails 20. The spacers 14 become space debris.

Accordingly, there is a need in the art for an improved nanosatellite system that can fill the unused volume in prior art satellite launchers and deployers.

### SUMMARY OF THE INVENTION

This patent document discloses a novel nanosatellite system and interface that fills unused volume in a CubeSat launcher with a nanosatellite format that retains all functions of a much larger CubeSats. The nanosatellite replaces a prior spacer, which has no function other than occupying a unused physical space with a functioning nanosatellite, without altering the functionality of the launcher or changing its physical property.

Among the objectives of the present nanosatellite device is the provision for a nanosatellite that utilizes unused volume in CubeSat deployer.

Another objective of the present nanosatellite device is the provision for a nanosatellite that provides low-cost entry to space for small startups, student teams and individuals.

Yet, another objective of the present nanosatellite device is the provision for a nanosatellite that Can support additional volume/system, e.g. up to 3U.

### BRIEF DESCRIPTION OF THE DRAWINGS

These and other features, aspects, and advantages of the present invention will become better understood with reference to the following description, appended claims, and accompanying drawings where:

FIG. 1 (prior art) shows a prior art CubeSat launcher;

FIG. 2 shows a side perspective view of an embodiment of the nanosatellite, that includes two camera lens holders as an exemplary payload;

FIG. 3 shows a partially exploded view of an embodiment of the nanosatellite;

FIG. 4 shows a partially exploded view of an embodiment of the nanosatellite with various components not illustrated in the lower portion;

FIG. 5 shows a perspective view of an embodiment of the nanosatellite with the solar panels arrays in the deployed position;

FIG. 6 shows a partial side view of the lower portion of an embodiment of the nanosatellite with the solar panel array deployed;

FIG. 7 shows a perspective view of Inset A of FIG. 6;

FIG. 8 shows a bottom perspective view of a solar panel array;

FIG. 9 shows a side view of an embodiment of the nanosatellite;

FIG. 10 shows a side view of an embodiment of the nanosatellite with 1U CubeSat bus attached thereto;

FIG. 11 shows a side view of an embodiment of the nanosatellite with 3U CubeSat bus attached thereto;

FIG. 12 shows a partial perspective view of the upper portion and upper surface of the lower portion of an embodiment of the nanosatellite;

FIG. 13A shows a transparent, inverted, bottom perspective view of an upper portion of an embodiment of the nanosatellite, showing the control subsystem contained therein;

FIG. 13B shows a bottom perspective view of an upper portion of an embodiment of the nanosatellite; and

FIG. 14 shows a partially exploded view of an upper portion of an embodiment of the nanosatellite.

### DESCRIPTION OF THE PREFERRED EMBODIMENT

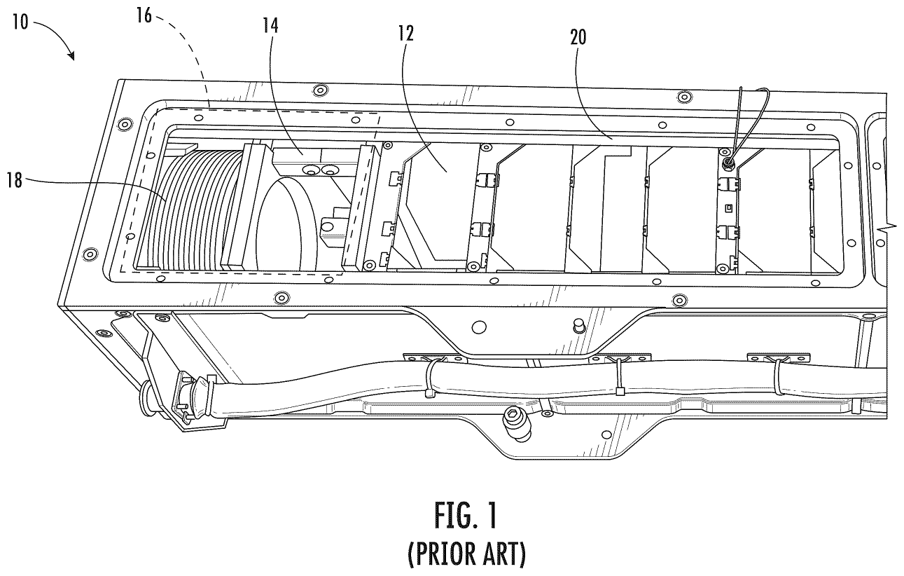

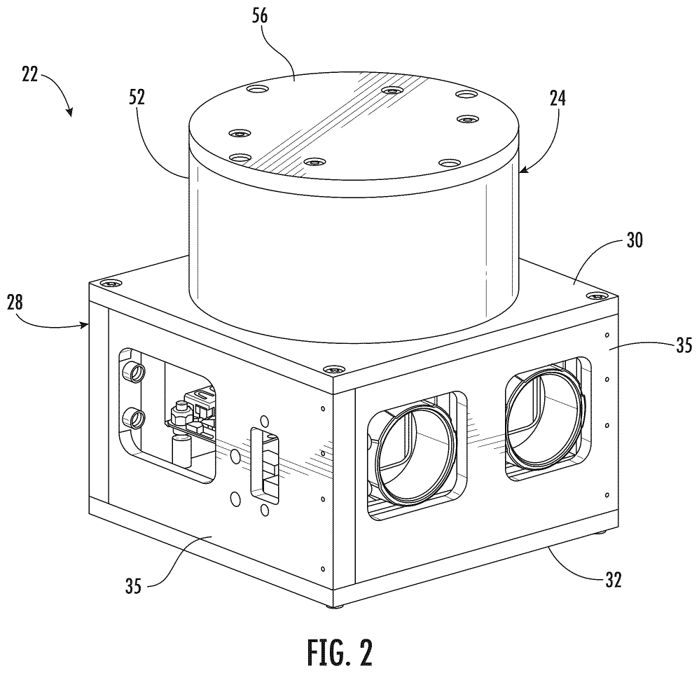

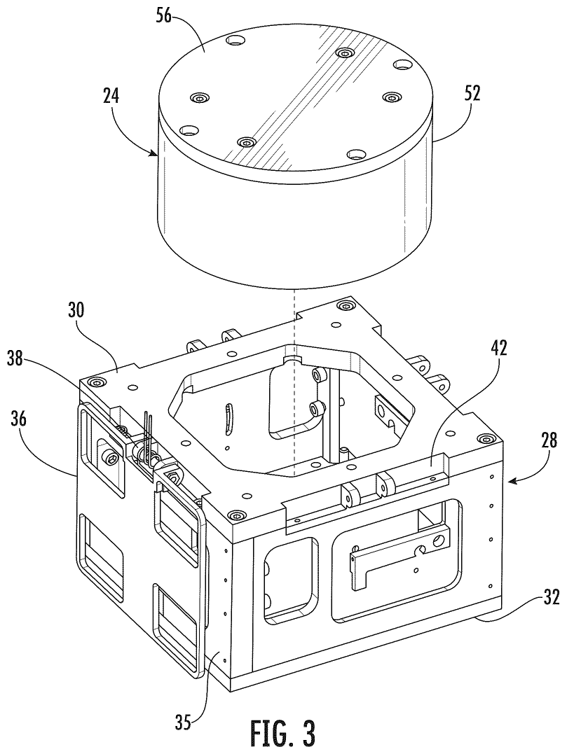

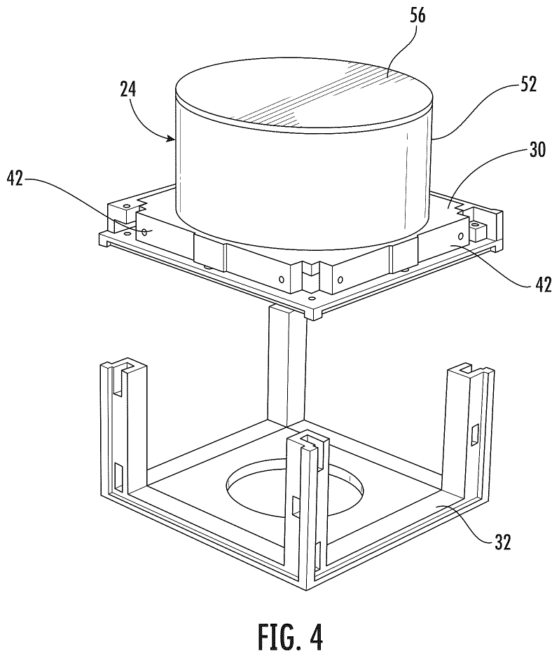

Referring to FIGS. 2-4, and as will be described in greater detail below, the present patent document discloses an embodiment of a nanosatellite 22 comprising of an upper portion 24, which houses the control subsystems 26 (also called spacecraft bus subsystems), and a lower portion 28, which can house a variety of payloads. The lower portion 28 sized and dimension to the fit within a nanosatellite launcher 10 housing and slidably engage with internal rails 20 on the launcher 10. The lower portion 28 has a top 30, bottom 32, left, right, front and rear 35 sides forming the payload housing. The top side 30 has a top surface configured and arranged to engage with a front end of the spring 18 of the launcher 10. The upper portion 24 extends from the top surface of the lower portion 28, and is sized and dimensioned to fit within the spring 18 of the launcher 10 (from FIG. 1).

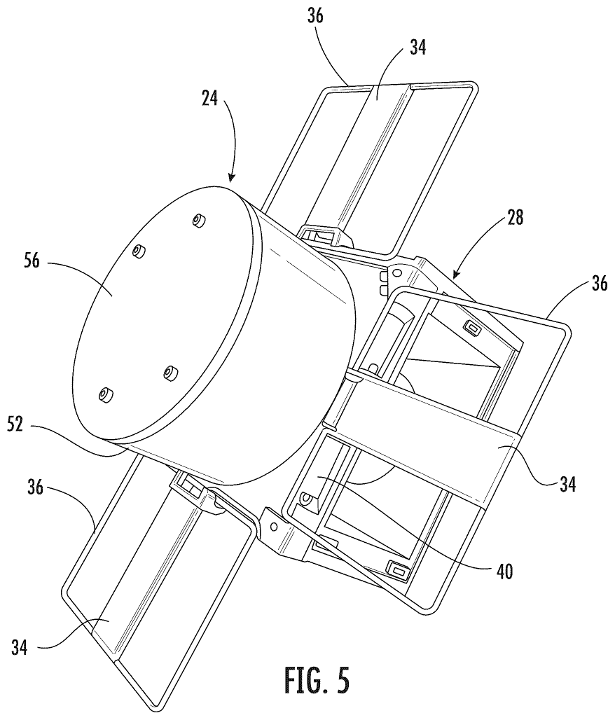

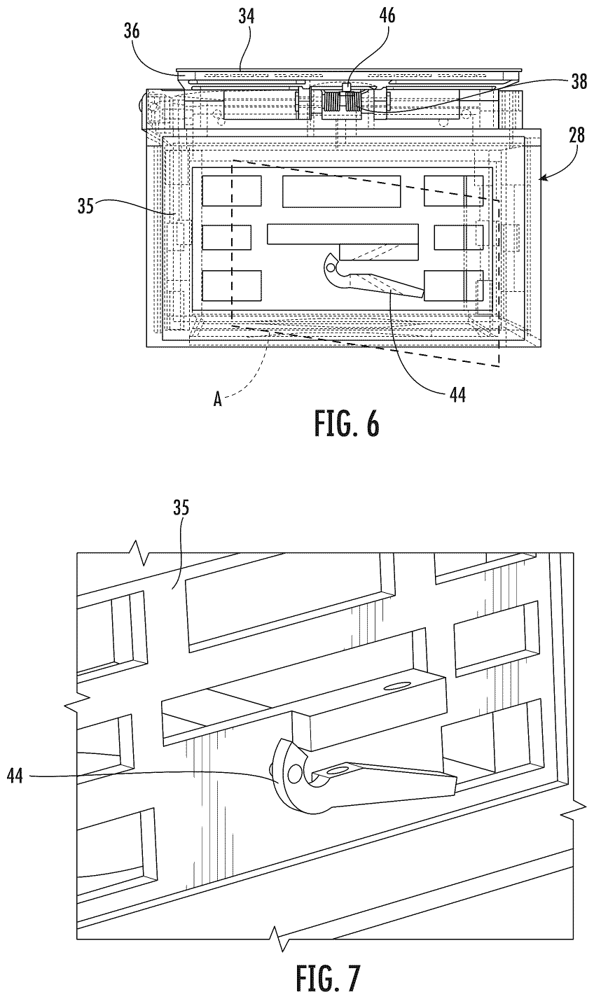

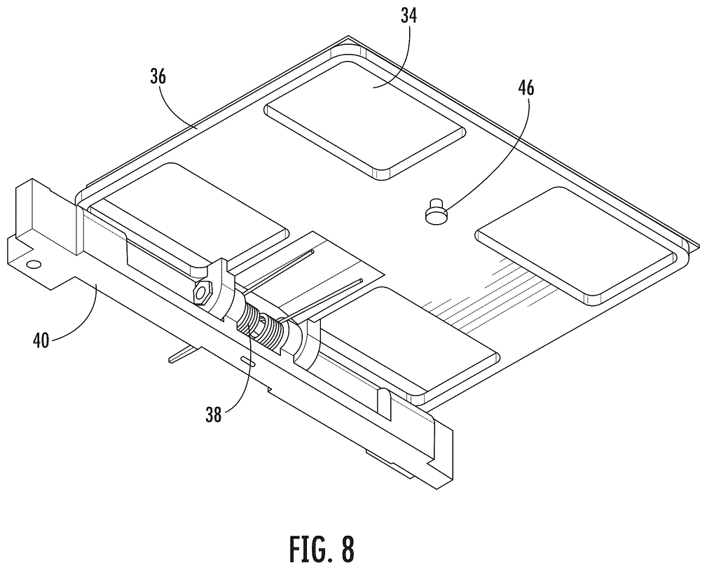

Referring to FIGS. 5-8, the nanosatellite 22 may be powered by a number of solar arrays 34. The solar arrays 34 may be mounted in a fixed position or extendable position on the lower portion 28 or upper portion 24 of the nanosatellite 22. In one embodiment, the solar arrays 34 are mounted on frame structures 36 which interface with the lower portion 28 through spring-loaded hinge mechanisms 38 connected to a support member 40 that is fastened to a recess 42 formed on the top side 30. The solar arrays held in place by a lever-and-latch mechanism which utilizes nitinol shape memory alloy in this embodiment. When an electric current is passed through the nitinol, it extends, moving the lever 44 and releasing the latch 46, allowing the solar array 34 and frame structure 36 to extend to a deployed position (best seen in FIG. 8). The nitinol is passed through holes in the side 35 wall of the lower portion 28 and into the payload section and the lever 44.

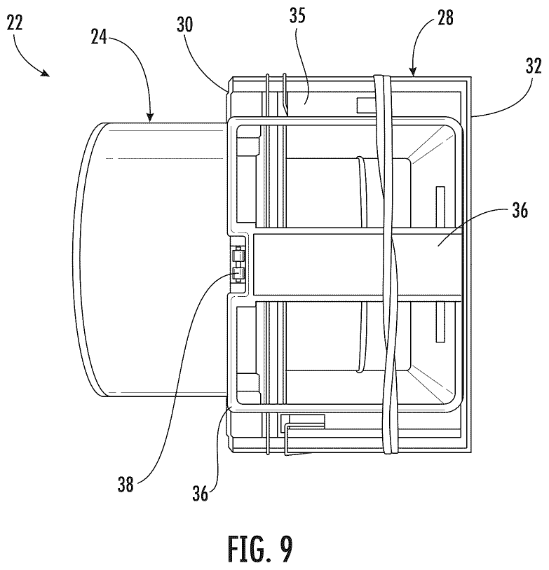

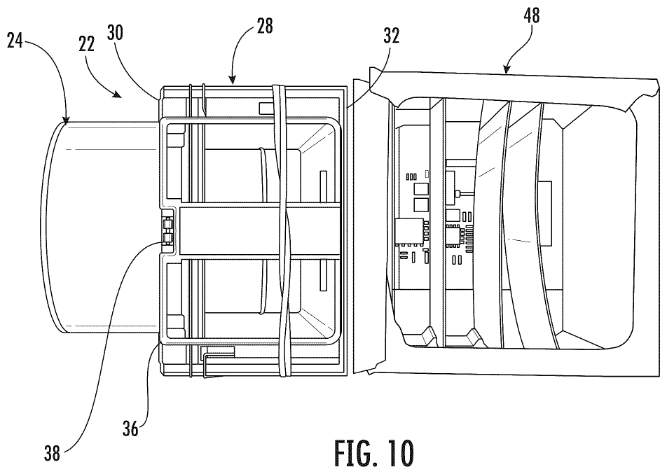

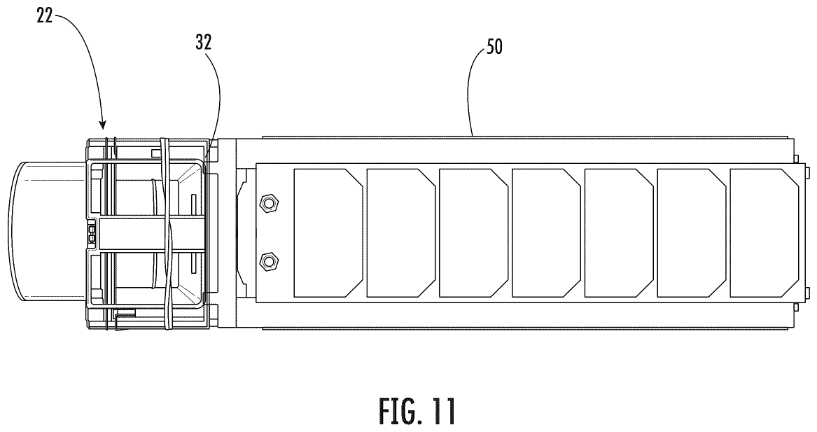

Referring to FIGS. 9-11, while the lower portion 28 is configured to hold 1/2U or less of payload (see FIG. 9) when all control subsystems are included in the upper portion 24, the nanosatellite device 22 can be configured to further include from 1U-3U of additional payload 48, 50 as is available in the launcher by coupling the additional payload modules to a bottom side 32 of the lower portion 28. For example, FIG. 10 shows the nanosatellite configured with an additional 1U payload module 48 and FIG. 11 shows the nanosatellite configured with an additional 3U payload module 50. The nanosatellite 22 may be reconfigured with additional payload modules 48, 50, volume permitting, in different launchers 10.

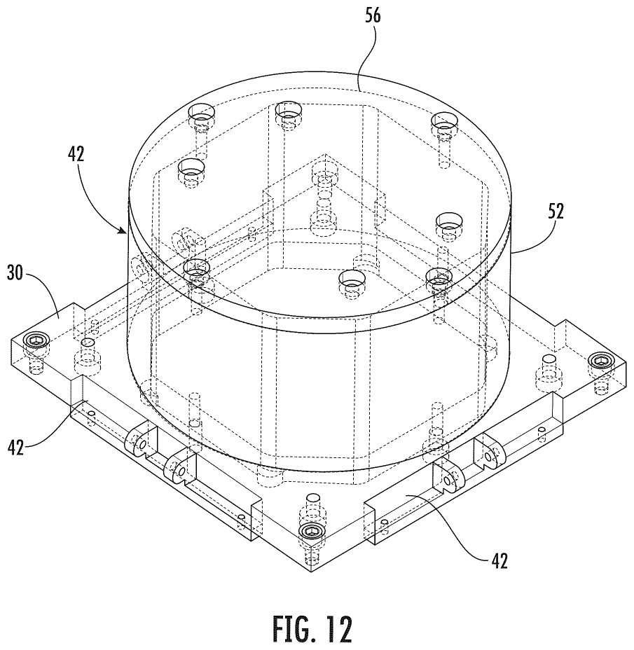

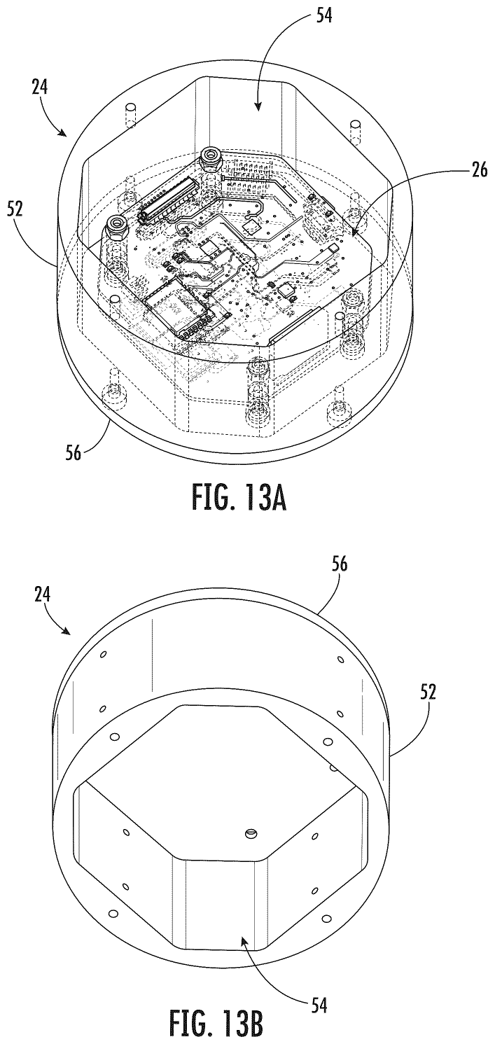

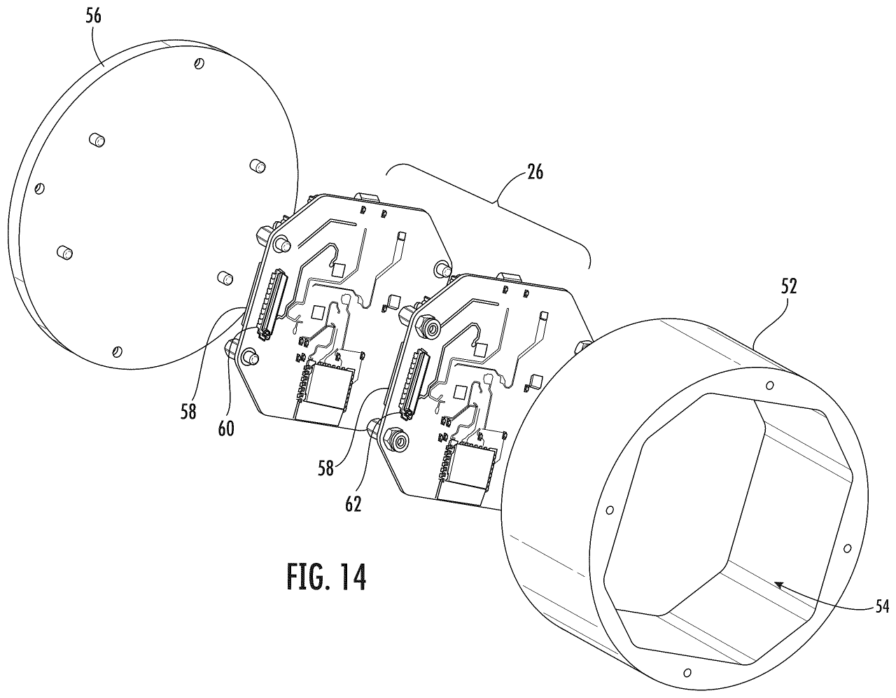

Referring to FIGS. 12, 13A, 13B, and 14, the upper portion 24 includes a cylindrical housing 52 with an open interior 54 configured to hold the control subsystems 26. A top lid 56 encloses the top end of the cylindrical housing 52 with the open bottom end of the cylindrical housing 52 being coupled to the top surface of the upper portion 28.

In one embodiment, the upper portion 28 features an octagonal interior cross-sectional profile and a circular exterior cross-sectional profile. Other interior cross-sectional profiles may be used. For instance, a circular or a hexagonal cross-sectional profile may be used to increase the usable interior space of the upper portion. The octagonal interior profile maximizes internal space to increase printed circuit board surface area of the control subsystem 26 while simultaneously maximizing structural integrity. The circular cross-sectional profile exterior allows the upper portion 24 to interface with launchers 10 having springs 18 with circular cross-sectional profiles, taking advantage of a volume which is typically left unused when the spring is compressed. In launchers 10 having square or rectangular spring cross-sectional profiles, the cross-sectional profile of the upper portion 24 may be modified accordingly to fit within the interior of the spring 18 to take advantage of the unused volume when the spring 18 is in a compressed state.

A complete nanosatellite control subsystem comprising all key systems necessary to a) power a scientific/technology payload, b) determination and control the nanosatellite attitude and c) bi-directional (space to ground and ground to space) communication are shown. The control subsystem 26 comprises a number of printed circuit boards 58 that are stacked vertically in the upper portion 24. Room is available in the upper portion 24 for additional printed circuit boards 58 providing additional functionality with minimal modification. Each board 58 has two connectors 60, 62 on either side, which allows multiple boards 58 to be stacked on top of one another. The stack is designed to allow up to four individually switched boards above and/or below a power supply board. The stack connector on the top carries signal common to all boards. The stack connector on the bottom carries signals specific to an experiment. Other boards may be connected to available GPIO pins from a microcontroller on the board 58.

Each board may include a microcontroller, such as a Raspberry Pi RP235xB. The microcontroller may be supported by either in-package 2 MiB of NOR flash, or on-board 2 or 4 MiB NOR flash. Each board has two connectors on either side. This allows multiple boards to be stacked on top of one another. Each board can either be powered over USB or through the stack connector. Reverse flow protection is enabled. Board power consumption is about 0.25 W. Micro-SD card will be supported.

The control subsystem can support a number of sensors. By way of example and not limitation, a Bosch BMI323 inertial measurement unit (combined accelerometer and gyroscope), Memsic MMC5983MA magnetometer (0.5 degree heading accuracy), Bosch BME680 combined humidity, pressure, temperature and air quality sensor, Bosch BMP390 high precision barometer and altimeter, 2×TI OPT3001 ambient light sensors, on each surface of the board may be provided.

LEDs may be installed on-board to indicate 5V, 3V3 power availability, as well as two LEDs connected to GPIO pins of the microcontroller for debugging and general use. These LEDs are not enabled by default, and for each class of LEDs a solder jumper needs to be connected on the board to light them up.

The control subsystem may include a number of input and output connectors, such as USB for programming, serial-over-USB debugging and communication; ARM SWD debug port for programming and advanced debugging with a debugger; Raspberry Pi RM2 WiFi and Bluetooth module for 802.11n and Bluetooth Low Energy 5.1 communication.

An RTOS-like, task-based software framework written in Rust, called embassy, may be used to program memory safe firmware for the board that lowers the power consumption of the system due to its interrupt-driven nature. MicroPython firmware may also be made available for the system to allow ease of programming where extreme fault tolerance, performance and power saving is not required.

Therefore, it can be seen that the present nanosatellite provides an improved nanosatellite system that can fill the unused volume in prior art satellite launchers and deployers. Further, the nanosatellite of the present disclosure provides a low cost and unique solution to educators and startups desiring to create nanosatellites.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A nanosatellite for a cube satellite launcher, the launcher having a launcher housing and spring with a front end and a rear end for deploying nanosatellites contained in the launcher housing, the nanosatellite comprising:
a lower portion sized and dimension to the fit within the launcher housing, the lower portion having a top, bottom, left, right, front and rear sides forming a payload housing, the top side having a top surface configured and arranged to engage with a front end of the spring of the launcher;
an upper portion extending from the top surface of the lower portion, the upper portion sized and dimensioned to fit within the spring of the launcher; and
a control subsystem contained within the upper portion.

2. The device of claim 1, further comprising a solar panel array connected to the lower portion, wherein the solar panel array is movable about a hinge between a stowed position against the lower portion and a deployed position extending outwardly from the lower portion.

3. The device of claim 2, further comprising four solar panel arrays connected to the bottom, left, right, front and rear sides, respectively, of the lower portion.

4. The device of claim 2, wherein the hinge is spring-loaded to deploy the solar panel array.

5. The device of claim 2, further comprising a lever and latch mechanism to selectively lock the solar panel array in the stowed position.

6. The device of claim 5, wherein the lever and latch mechanism comprises a lever having a nitinol shape memory alloy configured to extend when an electric current is passed therethrough, releasing a latch on the solar panel array.

7. The device of claim 1, further comprising a plurality of rails formed on the lower portion configured and arranged to slidably engage reciprocal rails on the launcher housing.

8. The device of claim 1, wherein the outside profile of the upper portion have a circular cross-sectional outer profile.

9. The device of claim 1, wherein the control subsystem comprises a vertical stack of a plurality of printed circuit boards interconnected via stackable connectors.

10. The device of claim 1, wherein the control subsystem comprises, a communications module, an attitude determination and control module, and a power module.

11. A nanosatellite for a cube satellite launcher, the launcher having a launcher housing and spring with a front end and a rear end for deploying nanosatellites contained in the launcher housing, the nanosatellite comprising:
a lower portion sized and dimension to the fit within the launcher housing, the lower portion having a top, bottom, left, right, front and rear sides forming a payload housing, the top side having a top surface configured and arranged to engage with a front end of the spring of the launcher;
an upper portion extending from the top surface of the lower portion, the upper portion sized and dimensioned to fit within the spring of the launcher, the upper portion having a circular cross-sectional outer profile; and
a control subsystem contained within the upper portion, the control subsystem comprising a vertical stack of a plurality of printed circuit boards interconnected via stackable connectors.

12. The device of claim 11, further comprising a solar panel array connected to the lower portion, wherein the solar panel array is movable about a hinge between a stowed position against the lower portion and a deployed position extending outwardly from the lower portion.

13. The device of claim 12, wherein the hinge is spring-loaded to deploy the solar panel array.

14. The device of claim 12, further comprising a lever and latch mechanism to selectively lock the solar panel array in the stowed position.

15. The device of claim 14, wherein the lever and latch mechanism comprises a lever having a nitinol shape memory alloy configured to extend when an electric current is passed therethrough, releasing a latch on the solar panel array.

16. The device of claim 11, wherein the control subsystem comprises, a communications module, an attitude determination and control module, and a power module.

17. A nanosatellite for a cube satellite launcher, the launcher having a launcher housing and spring with a front end and a rear end for deploying nanosatellites contained in the launcher housing, the nanosatellite comprising:
a lower portion sized and dimension to the fit within the launcher housing, the lower portion having a top, bottom, left, right, front and rear sides forming a payload housing, the top side having a top surface configured and arranged to engage with a front end of the spring of the launcher;
an upper portion extending from the top surface of the lower portion, the upper portion sized and dimensioned to fit within the spring of the launcher;
a solar panel array connected to the lower portion; and
a control subsystem contained within the upper portion.

18. The device of claim 18, wherein the solar panel array is movable about a spring-loaded hinge between a stowed position against the lower portion and a deployed position extending outwardly from the lower portion.

19. The device of claim 17, further comprising a lever and latch mechanism to selectively lock the solar panel array in the stowed position; wherein the lever and latch mechanism comprises a lever having a nitinol shape memory alloy configured to extend when an electric current is passed therethrough, releasing a latch on the solar panel array.

20. The device of claim 17, wherein the control subsystem comprises a vertical stack of a plurality of printed circuit boards interconnected via stackable connectors.
